(19) United States
(12) Patent Application Publication
(10) Pub. No.: US 2018/0153362 A1
(43) Pub. Date: Jun. 7, 2018

(54) TOILET SEAT DEVICE AND SUPPORTING DEVICE

(71) Applicant: Delta Electronics, Inc., Taoyuan City (TW)

(72) Inventors: Shih-Lin HUANG, Taoyuan City (TW); Chun-Lung CHIU, Taoyuan City (TW)

(21) Appl. No.: 15/434,383

(22) Filed: Feb. 16, 2017

(30) Foreign Application Priority Data
Dec. 6, 2016 (CN) 201621330474.3

(51) Int. Cl. A47K 13/30; A47K 17/02; H05B 1/02; G01K 1/14; G01B 11/14; G01J 5/00

(52) U.S. Cl. CPC A47K 13/305; A47K 17/02; H05B 1/0252; E03D 9/08; G01B 11/14; G01J 5/0025; G01K 1/14

(57) ABSTRACT

A toilet seat device is provided, including a toilet seat, at least one heat source, and at least one heat-conducting member. The toilet seat has at least one chamber therein. The heat source is disposed in the chamber. The heat-conducting member is disposed in the chamber and connected to the heat source for transferring the heat generated by the heat source to the toilet seat so that the toilet seat reaches a uniform temperature.

### CROSS REFERENCE TO RELATED APPLICATIONS

The present application claims priority of China Patent Application No. 201621330474.3, filed on Dec. 6, 2016, the entirety of which is incorporated by reference herein.

### BACKGROUND OF THE INVENTION

### Field of the Invention

The invention relates to a uniform temperature device, and in particular to a toilet seat device and a supporting device, such as a seat, a seat cushion, a back support, a pillow or a mattress, which can rapidly reach a uniform temperature.

### Description of the Related Art

Before a heated toilet seat is used, it can be pre-warmed to a temperature (e.g. 35 to 40° C.) that is closer to the body temperature of the user, so that the user may feel more comfortable.

In conventional heated toilet seats, an electric heating wire is commonly used as the heating element. FIG. 1 is a schematic view of a conventional heated toilet seat 200. It can be seen from the figure that an electric heating wire 202 wound in a plurality of turns is provided in the conventional heated toilet seat 200, and a power supply 204 provides electric power to the electric heating wire 202 for heating. Thus, the conventional heated toilet seat 200 has a heating effect and can maintain a uniform and constant temperature.

However, the thermal resistance of the electric heating wire 202 is very large, meaning that a power supply 204 that can deliver more power is required for achieving fast pre-heating. Existing heated toilet seats using electric heating wires usually require a long warm-up time. FIG. 2 is a heating curve of the conventional heated toilet seat 200 in FIG. 1. The time required for the conventional heated toilet seat 200 to reach a preset temperature (e.g. about 40° C.) is about 200 seconds. Therefore, it is inconvenient for the user to wait for such a long period of time before using the toilet seat.

### BRIEF SUMMARY OF THE INVENTION

In view of the aforementioned problems, an object of the invention is to provide a toilet seat device which can rapidly reach a uniform temperature (that is, the warm-up time can be reduced).

In some embodiments, a toilet seat device is provided, including a toilet seat, at least one heat source, and at least one heat-conducting member. The toilet seat has at least one chamber therein. The heat source is disposed in the chamber. The heat-conducting member is disposed in the chamber and connected to the heat source for transferring the heat generated by the heat source to the toilet seat so that the toilet seat reaches a uniform temperature.

In some embodiments, the heat-conducting member is a heat pipe or a vapor chamber.

In some embodiments, the toilet seat has a seating surface allowing the user to sit thereon, and the heat-conducting member abuts a wall of the chamber adjacent to the seating surface.

In some embodiments, the shape and length of the heat-conducting member correspond to the shape and length of the chamber.

In some embodiments, the heat source is disposed at one end or an arbitrary middle position of the heat-conducting member.

In some embodiments, the toilet seat device further includes a case and a toilet lid. The toilet seat and the toilet lid are pivotally connected to the case, and the toilet seat can be covered by the toilet lid. The toilet seat device further includes a controller disposed in the case for controlling the heating procedure and the heating temperature of the heat source.

In some embodiments, the toilet seat device further includes a start sensor disposed on the case for detecting the user's action and providing a start signal to the controller so that the controller controls the heat source to start heating based on the start signal.

In some embodiments, the start sensor is an optical sensor, a thermal sensor, an infrared sensor or a motion sensor.

In some embodiments, the toilet seat device further includes a temperature sensor disposed in the chamber for detecting the temperature of the toilet seat. The controller controls the heating procedure of the heat source based on the temperature of the toilet seat detected by the temperature sensor.

In some embodiments, the toilet seat device further includes an operation unit connected to the controller in the case through a wire. The operation unit allows the user to operate the buttons thereon, and then the heating temperature of the heat source is controlled by the controller.

In some embodiments, the toilet seat has a hollow frame, and the chamber conforms to the shape of the frame.

In some embodiments, the frame is made of a non-conductive material.

In some embodiments, the heat source is an electric heating piece.

In some embodiments, the toilet seat has a plurality of chambers therein, and each chamber has a heat source and a heat-conducting member disposed therein.

In some embodiments, the chambers are formed on the left and right sides of the toilet seat and separated from each other.

According to some embodiments, the heat-conducting member and the heat source may also be applied to other supporting devices (e.g. a seat, a seat cushion, a back support, a pillow or a mattress) that are used to support a part or parts of the user's body, so that the supporting devices have the function of keeping warm. Consequently, the comfort of using the supporting devices is also improved.

In order to illustrate the purposes, features, and advantages of the invention, the preferred embodiments and drawings of the invention are shown in detail as follows.

### BRIEF DESCRIPTION OF THE DRAWINGS

The invention can be more fully understood by reading the subsequent detailed description and examples with references made to the accompanying drawings, wherein:

FIG. 1 is a schematic view of a conventional heated toilet seat;

FIG. 2 is a heating curve of the conventional heated toilet seat in FIG. 1;

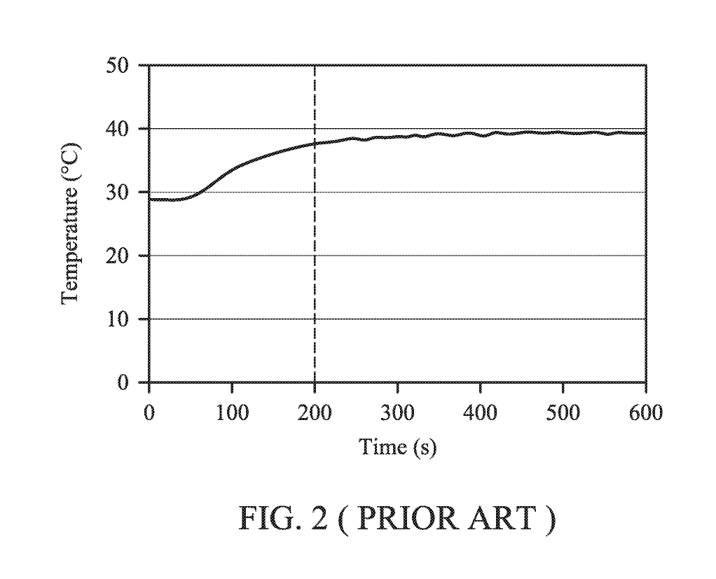

FIG. 3 is a schematic view of a toilet seat device in accordance with an embodiment of the invention;

FIG. 4 is a schematic view showing that the toilet seat in FIG. 3 is provided with a heat source and a heat-conducting member;

FIG. 5 is a cross-sectional view taken along line A-A in FIG. 4;

FIG. 6 is a heating curve of a toilet seat in accordance with an embodiment of the invention;

FIG. 7 is a schematic view showing that a toilet seat in accordance with another embodiment of the invention is provided with heat sources and heat-conducting members;

FIG. 8 is a schematic view of a supporting device in accordance with another embodiment of the invention; and

FIG. 9 is a cross-sectional view taken along line B-B in FIG. 8.

### DETAILED DESCRIPTION OF THE INVENTION

A detailed description is given in the following embodiments with reference to the accompanying drawings. This description is made for the purpose of illustrating the general principles of the invention and should not be taken in a limiting sense.

In the following detailed description, the orientations of “on”, “above”, “under”, , “below”, “left” and “right” are used for representing the relationship between the relative positions of each element as illustrated in the drawings, and are not meant to limit the invention.

Note that the present disclosure may repeat reference numerals and/or letters in the various examples. This repetition is for the purpose of simplicity and clarity and does not in itself dictate a relationship between the various embodiments and/or configurations discussed. Various features may be arbitrarily drawn in different scales for the sake of simplicity and clarity. Furthermore, some elements not shown or described in the embodiments have the forms known by persons skilled in the field of the invention.

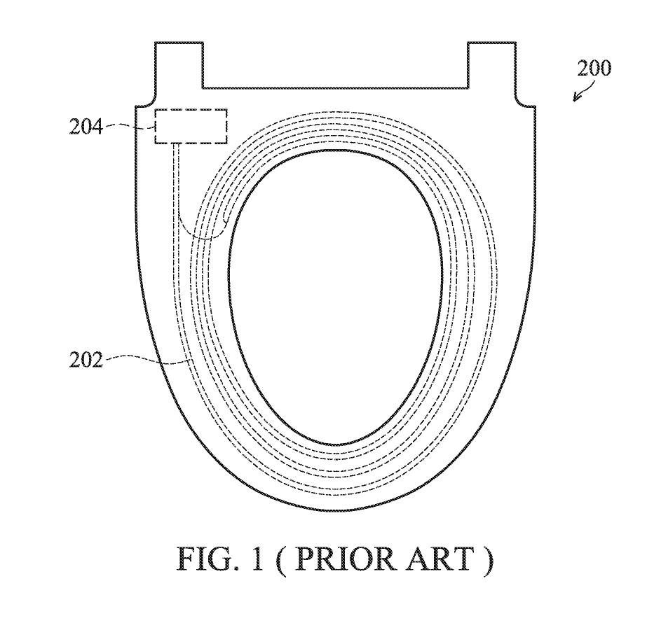

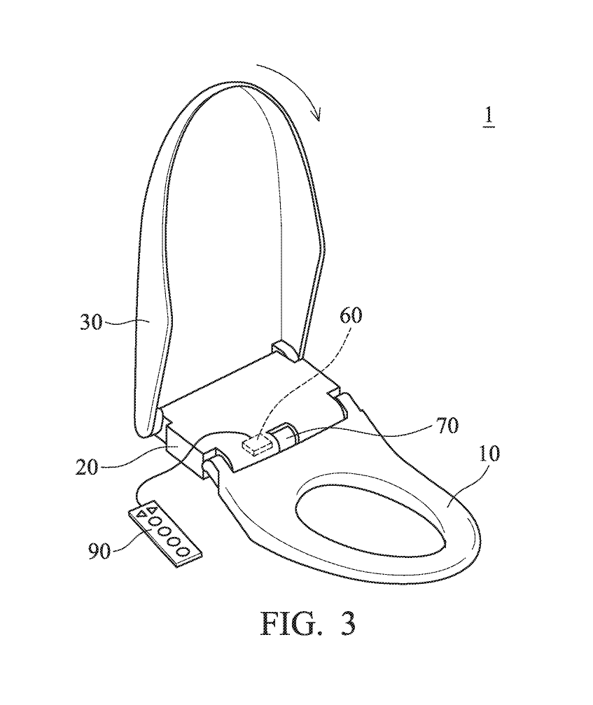

FIG. 3 is a schematic view of a toilet seat device 1 in accordance with an embodiment of the invention. The toilet seat device 1 is adapted to be disposed on a sitting toilet (not shown) in the restroom, including a toilet seat 10, a case 20, and a toilet lid 30. The case 20 is affixed to the sitting toilet and disposed between the toilet seat 10 and the toilet lid 30. The toilet seat 10 and the toilet lid 30 are pivotally connected to the case 20, so that the toilet seat 10 can be covered by the toilet lid 30 (as the arrow indicates in FIG. 1) or both the toilet seat 10 and toilet lid 30 can be raised up.

In addition, although not described below, the toilet seat device 1 may also be a bidet toilet seat device having a cleaning function of spraying water to the user's intergluteal cleft.

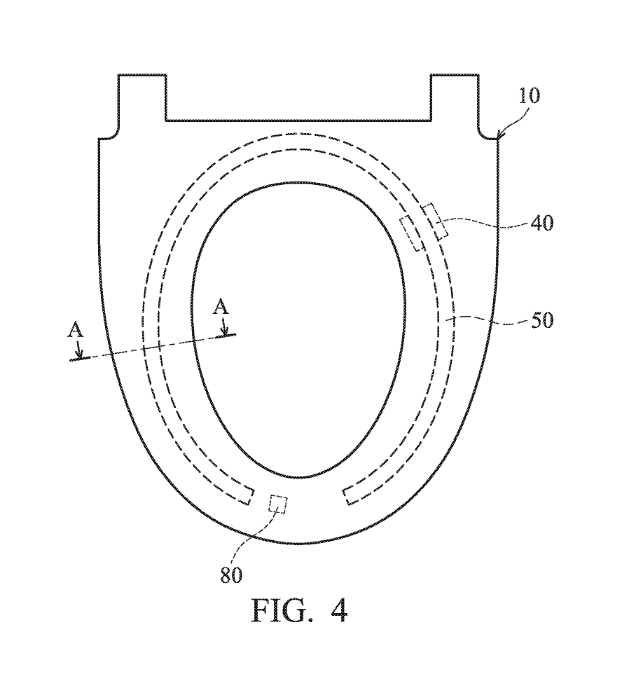

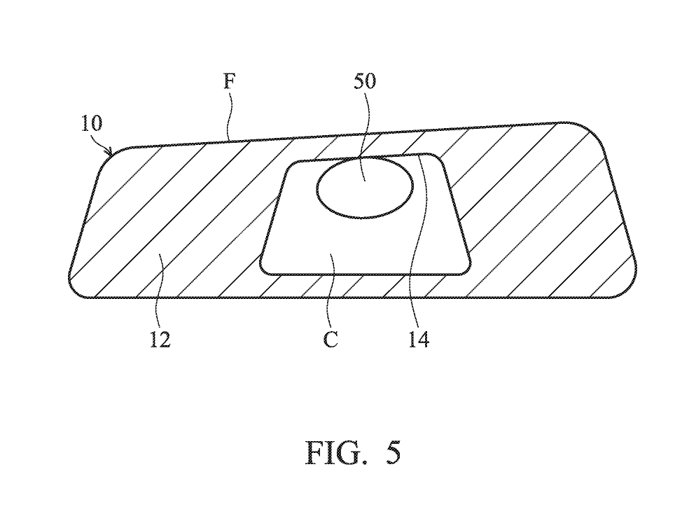

FIG. 4 is a schematic view showing that the toilet seat 10 in FIG. 3 is provided with a heat source 40 and a heat-conducting member 50, and FIG. 5 is a cross-sectional view taken along line A-A in FIG. 4. It can be seen from the figures that the toilet seat 10 has a closed chamber C, and a heat source 40 and a heat-conducting member 50 are disposed in the chamber C, in this embodiment.

Specifically, the toilet seat 10 has a hollow and oval frame 12 (but the invention is not limited to this shape). The frame 12 may be made of a non-conductive material such as resin and comprised of a single or multiple components. The top surface of the toilet seat 10 is a seating surface F allowing the user to sit thereon. The chamber 10 is formed in the toilet seat 10 and conforms to the shape of the frame 12 (that is, the chamber C is substantially oval in shape (not shown)). However, in some embodiments, the toilet seat 10 may also have a plurality of closed chambers C therein, such as two closed chambers C, wherein one of them is formed on the left side of the toilet seat 10 and the other is formed on the right side thereof. The closed chambers C are separated from each other. Moreover, each closed chamber C has a heat source 40 and a heat-conducting member 50 disposed therein.

The heat source 40 is disposed in the chamber C. In some embodiments, the heat source 40 may be a soft or hard electric heating piece or another optional heating element sized to fit into the chamber C. The operating temperature (i.e. the heating temperature) of the heat source 40 is preferably in a range of about 30 to 80° C., and the surface temperature of the toilet seat 10 is preferably lower than 45° C.

The heat-conducting member 50 is disposed in the chamber C and connected to (or in contact with) the heat source 40. The heat-conducting member 50 abuts a (top) wall 14 of the chamber C adjacent to the seating surface F of the toilet seat 10. In some embodiments, the heat-conducting member 50 is attached to the wall 14 (as shown in FIG. 5) or may be supported by a support body in the chamber C. In addition, the heat-conducting member 50 is an elongated member, and its shape and length correspond to the shape (oval) and length of the chamber C.

In this embodiment, the heat-conducting member 50 is a heat pipe consisting of a sealed tubular vessel, a small amount of working liquid filled in the vessel, and a capillary structure or wick formed on the inner wall of the vessel. With the change of two-phase of the working fluid circulated in the vessel and the convection between the liquid and gaseous working fluid in the endothermic end and exothermic end, the surface of the heat pipe can rapidly reach a uniform temperature, thereby achieving heat transfer. Moreover, by selecting different working fluids, the heat pipe can have different operating temperature ranges (the operating temperature range is the temperature range suitable for heat transfer). In some embodiments, the working fluid used in the heat pipe may be pure water, alcohol, or a mixture of water and alcohol, so that the operating temperature of the heat pipe (heat-conducting member 50) matches the operating temperature of the heat source 40.

In some embodiments, the heat-conducting member 50 may also be a vapor chamber. The working principle of the vapor chamber is similar to that of the heat pipe described above, the only difference being that the vapor chamber is a plate-shaped member (that is, the vapor chamber includes a sealed plate-shaped vessel).

Note that the heat pipe and the vapor chamber all have the advantages of a low starting temperature, fast thermal response, and small temperature difference.

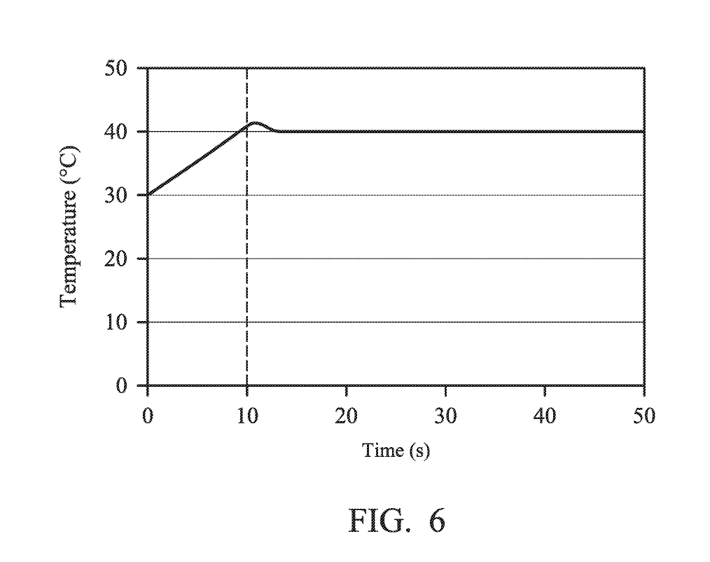

Therefore, the heat generated by the heat source 40 can be rapidly and uniformly transferred to the entire toilet seat 10 through the heat-conducting member 50 (heat pipe or vapor chamber), so that the toilet seat 10 reaches a uniform temperature. FIG. 6 is a heating curve of the toilet seat 10 of the toilet seat device 1 (see FIGS. 3˜5) according to an embodiment of the invention. It can be seen from FIG. 6 that the time required for preheating the toilet seat to reach a preset temperature (e.g. about 40° C.) is only about 10 seconds. Therefore, the problem of the warm-up time of conventional heated toilet seats using electric heating wires being too long is effectively solved and the convenience to the user is increased.

Owing to the above-mentioned characteristics of the heat pipe or vapor chamber, the position of the heat source 40 in the chamber C is also not restricted. In other words, the heat source 40 may be disposed at one end or an arbitrary middle position of the heat-conducting member 50 (that is, only a local heat source is needed), and it does not affect the ability of the entire heat-conducting member 50 to rapidly reach a uniform temperature.

Furthermore, since the thermal resistance of the heat pipe or vapor chamber is much lower than that of the electric heating wire, a lower-power heat source 40 may be used, so as to save energy and improve safety.

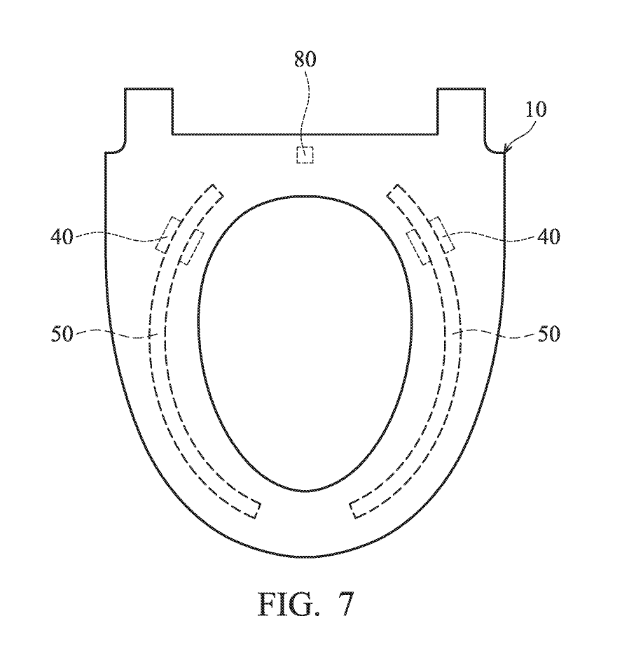

Although only a heat source 40 and a heat-conducting member 50 are provided in the toilet seat 10 in the above embodiment, the invention is not limited thereto. FIG. 7 is a schematic view showing that a toilet seat 10 in accordance with another embodiment of the invention is provided with heat sources 40 and heat-conducting members 50. It can be seen from the figure that the number of heat sources 40 and heat-conducting members 50 in the toilet seat 10 may also be plural (e.g. two), and the heat sources 40 and heat-conducting members 50 are provided in pairs and on the left and right sides of the toilet seat 10, respectively.

Referring to FIG. 3 and FIG. 4, the toilet seat device 1 of this embodiment further includes a controller 60, a start sensor 50, a temperature sensor 80, and an operation unit 90.

The controller 60 is disposed in the case 20 and electrically connected to the heat source 40 in the chamber C of the toilet seat 10 through a wire (not shown). The controller 60 can provide a control signal to the heat source 40 to control its heating procedure and heating temperature.

The start sensor 70 is disposed on the case 20 and is electrically connected to the controller 60 through a wire (not shown). The start sensor 70 is used to detect the user's action and provides a start signal to the controller 60 so that the controller 60 controls the heat source 40 to start heating based on the start signal.

Specifically, the start sensor 70 may detect the user's location or body temperature to determine whether the user is about to use the toilet seat device 1. For example, the start sensor 70 may be an optical sensor (e.g. a photoelectric sensor) for detecting the distance from the user. When the user stands before the toilet seat device 1 or is about to sit on the toilet seat 10, the start sensor 70 may detect that the distance between itself and the user is less than a certain distance to determine that the user is about to use the toilet seat device 1. Alternatively, the start sensor 70 (optical sensor) may receive light from the environment when the user lifts the toilet lid 30 and thereby learns that the user starts to use the toilet seat device 1. Alternatively, the start sensor 70 may be a thermal sensor (e.g. a pyroelectric sensor) that can detect a temperature change signal when the user is about to sit on the toilet seat 10 to determine the user starts to use the toilet seat device 1. It should be appreciated that the start sensor 70 may also be an infrared sensor, a motion sensor, or another form of sensor that can be used.

The temperature sensor 80 is disposed on the chamber C of the toilet seat 10, for example, the temperature sensor 80 may be attached to the (top) wall 14 of the chamber C, and electrically connected to the controller 60 through a wire (not shown). The temperature sensor 80 is used to detect the temperature of the toilet seat 10, and the controller 60 controls the heating procedure of the heat source 40 based on the temperature of the toilet seat 10 detected by the temperature sensor 80. For example, when the temperature sensor 80 detects that the temperature of the toilet seat 10 has reached a preset temperature (e.g. about 40° C.), the controller 60 can stop the heat source 40 from heating; whereas, when the temperature sensor 80 detects that the temperature of the toilet seat 10 is lower than a certain temperature (e.g. about 30° C.) which may cause the user discomfort, the controller 60 can control the heat source 40 to reheat. Thus, the purpose of saving energy can also be achieved.

The operation unit 90 is an external operation unit that is electrically connected to the controller 60 in the case 20 through a wire (not shown). The operation unit 90 allows the user to operate the buttons thereon to select or adjust the desired temperature of the toilet seat 10, and then the heating temperature of the heat source 40 is controlled by the controller 60.

As mentioned above, the invention provides a toilet seat device, in which a heat-conducting member (heat pipe or vapor chamber) and a low-power heat source is used to replace the heating element (electric heating wire) and the high-power power supply used in the prior art. Therefore, the toilet seat can be preheated quickly and warmed uniformly without needing a long warm-up time and energy consumption, thereby saving energy. Moreover, by using the controller, the operation unit and various sensors described above, the operational comfort of the toilet seat device can also be greatly improved.

The aforementioned technique of using a heat-conducting member (a heat pipe or a vapor chamber) and a low-power heat source to reduce the warm-up time (i.e. rapid heating) and to quickly reach a uniform temperature is not limited to application in a toilet seat device. It can also be applied in supporting devices (e.g. a seat, a seat cushion, a back support, a pillow or a mattress) that are used to support a part or parts of the user's body so that the supporting devices have a function of keeping warm, thereby improving the comfort of using the supporting devices.

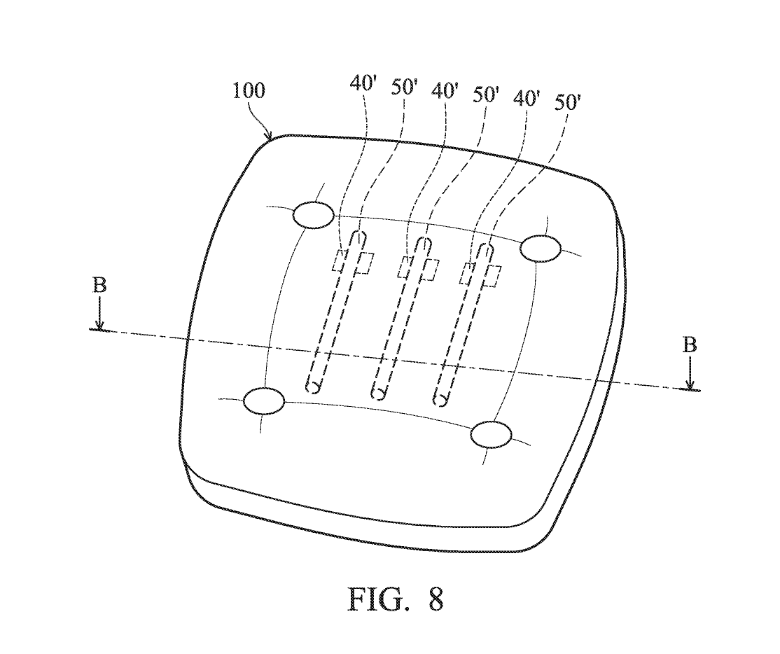

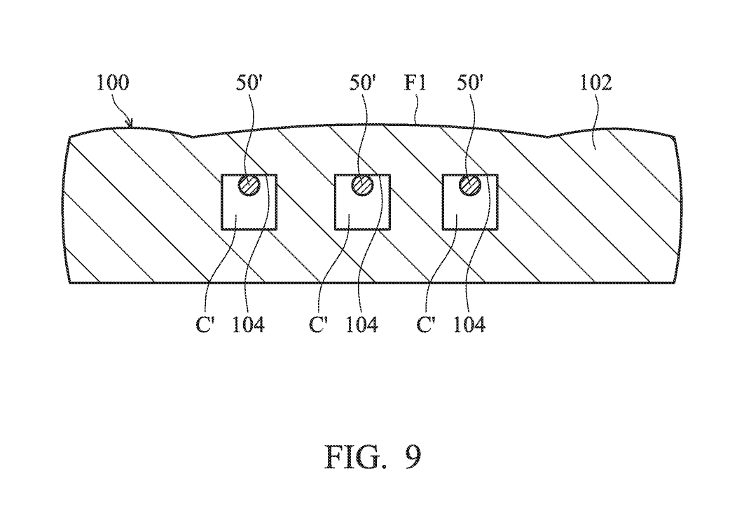

FIG. 8 is a schematic view of a supporting device 100 in accordance with another embodiment of the invention, and FIG. 9 is a cross-sectional view taken along line B-B in FIG. 8. As shown in FIGS. 8 and 9, the supporting device 100 is, for example, a seat cushion including a main body 102. The main body 102 has a plurality of closed and elongated chambers C′ therein, and each chamber C′ is provided with a heat source 40′ and an elongated heat-conducting member 50′. However, in some embodiments, the main body 102 may also have a single closed chamber C′ therein, and the closed chamber C′ is designed to meander (not shown) to cover the entire main body 102 (i.e. to match the size and shape of the main body 102). In those cases, one or multiple heat sources 40′ may be provided in the chamber C′, and one or multiple heat-conducting members 50′ may be provided in the chamber C′.

The heat source 40′ may be disposed at one end or an arbitrary middle position of the heat-conducting member 50′. The heat source 40′ and heat-conducting member 50′ are the same as the heat source 40 and heat-conducting member 50 in the above embodiment, and thus the details thereof are not repeated here.

As shown in FIG. 9, the top surface of the main body 102 of the supporting device 100 is a supporting surface F1 used to contact and support a part or parts (e.g. buttock) of the user's body (not shown). Preferably, the heat-conducting member 50′ abuts a (top) wall 104 of the chamber C′ adjacent to the supporting surface F1 of the main body 102. With the above structural designs, the heat generated by the heat source 40′ can be rapidly and uniformly transferred to the entire main body 102 through the heat-conducting member 50′ (heat pipe or vapor chamber), so that the main body 102 reaches a uniform temperature. Consequently, the comfort of using the supporting device 100 is improved.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A toilet seat device, comprising:
a toilet seat having a plurality of closed chambers therein;
a plurality of heat sources respectively disposed in the closed chambers; and
a plurality of heat conducting members respectively disposed in the closed chambers and connected to the corresponding heat source for transferring the heat generated by the heat source to the toilet seat so that the toilet seat reaches a uniform temperature.

2. The toilet seat device as claimed in claim 1, wherein the heat-conducting member is a heat pipe or a vapor chamber.

3. The toilet seat device as claimed in claim 1, wherein the toilet seat has a seating surface allowing a user to sit thereon, and the heat-conducting member abuts a wall of the closed chamber adjacent to the seating surface.

4. The toilet seat device as claimed in claim 1, wherein the shape and length of the heat-conducting member correspond to the shape and length of the corresponding closed chamber.

5. The toilet seat device as claimed in claim 4, wherein the heat source is disposed at one end or an arbitrary middle position of the heat-conducting member.

6. The toilet seat device as claimed in claim 1, further comprising a case and a toilet lid, wherein the toilet seat and the toilet lid are pivotally connected to the case, and the toilet seat can be covered by the toilet lid, and the toilet seat device further comprises a controller disposed in the case for controlling a heating procedure and a heating temperature of the heat source.

7. The toilet seat device as claimed in claim 6, further comprising a start sensor disposed on the case for detecting a user's action and providing a start signal to the controller so that the controller controls the heat source to start heating based on the start signal.

8. The toilet seat device as claimed in claim 7, wherein the start sensor is an optical sensor, a thermal sensor, an infrared sensor or a motion sensor.

9. The toilet seat device as claimed in claim 6, further comprising a temperature sensor disposed in the closed chamber for detecting a temperature of the toilet seat, and the controller controls the heating procedure of the heat source based on the temperature of the toilet seat detected by the temperature sensor.

10. The toilet seat device as claimed in claim 6, further comprising an operation unit connected to the controller in the case through a wire, wherein the operation unit is configured to allow a user to operate buttons thereon, such that the heating temperature of the heat source is controlled by the controller.

11. (canceled)

12. The toilet seat device as claimed in claim 1, wherein the toilet seat is made of a non-electric conductive material.

13. The toilet seat device as claimed in claim 1, wherein the heat source is an electric heating piece.

14. (canceled)

15. The toilet seat device as claimed in claim 1, wherein the closed chambers are formed on the left and right sides of the toilet seat and separated from each other.

16. A supporting device, comprising:
a main body having a plurality of closed chambers therein;
a plurality of heat sources respectively disposed in the closed chambers; and
a plurality of heat conducting members respectively disposed in the closed chambers and corresponding connected to the heat source for transferring the heat generated by the heat source to the main body so that the main body reaches a uniform temperature.

17. The supporting device as claimed in claim 16, wherein the heat-conducting member is a heat pipe or a vapor chamber.

18. The supporting device as claimed in claim 16, wherein the main body has a supporting surface used to contact a part of a user's body, and the heat-conducting member abuts a wall of the closed chamber adjacent to the supporting surface.

19. The supporting device as claimed in claim 16, wherein the heat source is disposed at one end or an arbitrary middle position of the heat-conducting member.

20. The supporting device as claimed in claim 16, wherein the supporting device is a seat, a seat cushion, a back support, a pillow or a mattress.
